(19) United States
(12) Patent Application Publication
(10) Pub. No.: US 2011/0042983 A1
(43) Pub. Date: Feb. 24, 2011

(54) NOZZLE FOR HOLDING A SUBSTRATE AND APPARATUS FOR TRANSFERRING A SUBSTRATE INCLUDING THE SAME

(76) Inventors: Jun-Hee YI, Asan-si (KR); Tea-Seog Um, Asan-si (KR); Byung-Soo Kim, Cheonan-si (KR); Ki-Taik Oh, Cheonan-si (KR); Dong-Hyeon Kim, Asan-si (KR); Dong-Goon Jung, Cheonan-si (KR); Jin-Pyo Lee, Cheonan-si (KR); Hyun Jung Kim, Asan-si (KR); Myung-Sup Han, Asan-si (KR)

Correspondence Address: F. CHAU & ASSOCIATES, LLC, 130 WOODBURY ROAD, WOODBURY, NY, 11797, US

(21) Appl. No.: 12/834,266

(22) Filed: Jul. 12, 2010

(30) Foreign Application Priority Data
Aug. 20, 2009 (KR) 10-2009-0077078

(51) Int. Cl. B25J 15/06; B66C 1/02

(52) U.S. Cl. 294/65

(57) ABSTRACT

A nozzle for holding a substrate may include a nozzle head and a nozzle body. The nozzle head may provide the substrate with compressed air. The nozzle body may be connected to the nozzle head. The nozzle body may be arranged facing the semiconductor substrate. The nozzle body may have a substantially flat supporting surface which provides a uniform gap between the substrate and the nozzle body. The nozzle body may have a first passageway which allows the compressed air to pass through toward the substrate to form a vacuum between the substantially flat supporting surface and the substrate.

### CROSS-REFERENCE TO RELATED APPLICATION

This application claims priority under 35 USC §119 to Korean Patent Application No. 10-2009-0077078, filed on Aug. 20, 2009, the disclosure of which is hereby incorporated by reference herein in its entirety.

### BACKGROUND

1. Technical Field

Example embodiments relate to a nozzle for holding a substrate and an apparatus for transferring a substrate including the same. More particularly, example embodiments relate to a non-contact type nozzle for holding a substrate using a vacuum, and an apparatus for transferring a substrate including the nozzle.

2. Description of the Related Art

Generally, a semiconductor device may be manufactured by a plurality of processes. Thus, an apparatus for transferring a semiconductor substrate to unit processes may be required.

The transferring apparatus may be classified into either a contact type transferring apparatus and a non-contact type transferring apparatus. The contact type transferring apparatus may include a holder configured to directly make contact with the semiconductor substrate. In contrast, the non-contact type transferring apparatus may transfer the semiconductor substrate using a vacuum. That is, the non-contact type transferring apparatus may not directly make contact with the semiconductor substrate.

Here, minute contaminants may have a negative effect on the semiconductor substrate. Because there may exist a high possibility that the contact type transferring apparatus may deliver the contaminants to the semiconductor substrate, the non-contact type transferring apparatus may be widely used.

Further, the non-contact type transferring apparatus may be classified into either a direct vacuum type transferring apparatus and an indirect vacuum type transferring apparatus. The direct vacuum type transferring apparatus may directly provide the semiconductor substrate with a vacuum. In contrast, the indirect vacuum type transferring apparatus may form a vacuum between the transferring apparatus and the semiconductor substrate using compressed air.

The direct vacuum type transferring apparatus may include a porous holder through which the vacuum may pass. However, it may be difficult to control the vacuum. Further, particles in the porous holder may act as contaminants. Therefore, the indirect vacuum type transferring apparatus is recently being used.

The indirect vacuum type transferring apparatus may include a plurality of nozzles installed in a nozzle plate. The compressed air may be sprayed through the nozzles toward an edge of the semiconductor substrate to form the vacuum between the semiconductor substrate and the nozzles, thereby floating the semiconductor substrate.

However, a portion of the thin semiconductor substrate corresponding to a central portion of the nozzle may be upwardly bent due to the vacuum, so that the semiconductor substrate may be frequently damaged.

Further, the compressed air may be concentrated on a lower central surface of the nozzle plate. This concentrated compressed air may downwardly bend a central portion of the semiconductor substrate.

Thus, there is a need in the art for a nozzle for holding a substrate that may be capable of suppressing the bending of the substrate and for an apparatus for transferring a substrate including the above-mentioned nozzle.

### SUMMARY

Example embodiments may provide a nozzle for holding a substrate that may be capable of suppressing the bending of the substrate.

Example embodiments may also provide an apparatus for transferring a substrate including the above-mentioned nozzle.

According to some example embodiments, there is provided a nozzle for holding a substrate. The nozzle may include a nozzle head and a nozzle body. The nozzle head may provide the substrate with compressed air. The nozzle body may be connected to the nozzle head. The nozzle body may be arranged facing the semiconductor substrate. The nozzle body may have a substantially flat supporting surface which provides a uniform gap between the substrate and the nozzle body. The nozzle body may have a first passageway which allows the compressed air to pass through toward the substrate to form a vacuum between the substantially flat supporting surface and the substrate.

In some example embodiments, the nozzle body may further have a second passageway for providing the compressed air to a portion of the substrate corresponding to a central portion of the nozzle body so as to prevent an upward bending of the substrate by the vacuum. The second passageway may have a cross-sectional area smaller than that of the first passageway.

According to some example embodiments, there is provided a nozzle for holding a substrate. The nozzle may include a nozzle head and a nozzle body. The nozzle head may provide the substrate with compressed air. The nozzle body may be connected to the nozzle head. The nozzle body may have a substantially flat supporting surface facing the substrate. The nozzle body may have a first passageway and a second passageway. The first passageway allows the compressed air to pass through toward the substrate to form a vacuum between the substantially flat supporting surface and the substrate. The second passageway allows the compressed air to pass through toward a portion of the substrate corresponding to a central portion of the nozzle body so as to prevent an upward bending of the substrate by the vacuum.

According to some example embodiments, there is provided an apparatus for transferring a substrate. The apparatus may include a nozzle plate and a plurality of nozzles. The nozzle plate may be arranged over the substrate. The nozzles may be installed at the nozzle plate. Each of the nozzles may have a substantially flat supporting surface which provides a uniform gap between the substrate and the nozzle. Each of the nozzles may have a first passageway for allowing the compressed air to pass through toward the substrate to form a vacuum between the substantially flat supporting surface and the substrate.

In some example embodiments, the nozzle plate may have a receiving groove configured to receiving the compressed air so as to prevent a downward bending of a central portion of the substrate by the compressed air.

In some example embodiments, the apparatus may further include a vacuum sensor attached to the nozzle plate to detect the floating of the substrate. The vacuum sensor may include a pad configured to directly make contact with the substrate for preventing a sliding of the substrate.

According to some example embodiments, the compressed air may be supplied to the substrate through the central portion of the nozzle, so that the upward bending of the nozzle caused by the vacuum may be suppressed. Further, the compressed air sprayed from the nozzles may be received in the receiving grooves of the nozzle plate. Thus, the pressure of the compressed air applied to the central portion of the substrate may be decreased, so that the downward bending of the substrate may be suppressed.

### BRIEF DESCRIPTION OF THE DRAWINGS

Example embodiments will be more clearly understood from the following detailed description taken in conjunction with the accompanying drawings. FIGS. 1 to 5 represent non-limiting, example embodiments as described herein.

FIG. 1 is a cross-sectional view illustrating a nozzle for holding a substrate in accordance with an example embodiment;

FIG. 2 is a perspective view illustrating an apparatus for transferring a substrate including the nozzle in FIG. 1;

FIG. 3 is a bottom perspective view illustrating the apparatus in FIG. 2;

FIG. 4 is a cross-sectional view illustrating a nozzle plate of the apparatus in FIG. 2; and

FIG. 5 is a cross-sectional view illustrating a vacuum sensor of the apparatus in FIG. 3.

### DETAILED DESCRIPTION OF THE EXAMPLE EMBODIMENTS

Various example embodiments will be described more fully hereinafter with reference to the accompanying drawings, in which some example embodiments are shown. The present invention may, however, be embodied in many different forms and should not be construed as limited to the example embodiments set forth herein. Rather, these example embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments will be explained in detail with reference to the accompanying drawings.

Nozzle for Holding a Substrate

FIG. 1 is a cross-sectional view illustrating a nozzle for holding a substrate in accordance with some example embodiments.

Referring to FIG. 1, a nozzle 100 for holding a substrate in accordance with this example embodiment may include a nozzle head 110 and a nozzle body 120.

The nozzle head 110 may be located over an object. In some example embodiments, the object may include a semiconductor substrate having a thin thickness. The nozzle head 110 may provide the semiconductor substrate with compressed air.

The nozzle body 120 may be arranged under the nozzle head 110. The nozzle body 120 may be connected to the nozzle head 110. Thus, the nozzle body 120 may receive the compressed air from the nozzle head 110. Thus, the nozzle body 120 may be arranged facing the semiconductor substrate. The nozzle body 120 may have a supporting surface 122 arranged facing the semiconductor substrate to support the semiconductor substrate.

In some example embodiments, the supporting surface 122 may have, for example, a flat structure without a stepped portion. Thus, a uniform gap may be formed between the supporting surface 122 and the semiconductor substrate. A gap between a central portion of the supporting surface 122 and the semiconductor substrate may be substantially the same as that between an edge portion of the supporting surface 122 and the semiconductor substrate.

The nozzle body 120 may have a first passageway 124 through which the compressed air may pass. The first passageway may extend from an upper central surface of the nozzle body 120 to a lower edge surface of the nozzle body 120 through a side portion of the nozzle body 120. Therefore, the compressed air may be sprayed from the lower edge surface of the nozzle body 120 toward a radius direction of the semiconductor substrate. Here, air between the supporting surface 122 and the semiconductor substrate may be moved together with the compressed air along the radius direction of the semiconductor substrate to form a vacuum between the supporting surface 122 and the semiconductor substrate. As a result, the semiconductor substrate may be floated toward the supporting surface 122.

Here, as mentioned above, because the supporting surface 122 may have the flat structure, a space between the supporting surface 122 and the semiconductor substrate may have a rectangular shape. Thus, the vacuum may be uniformly applied to the semiconductor substrate. As a result, an upward bending of a portion of the semiconductor substrate, which may correspond to a central portion of the supporting surface 122, cause by non-uniform vacuum may be suppressed.

Additionally, the nozzle body 120 may have a second passageway 126 through which the compressed air may pass. The second passageway 126 may extend from the upper central surface of the nozzle body 120 to a lower central surface of the nozzle body 120 along a vertical direction. Thus, the compressed air introduced into the second passageway 126 may be sprayed from the lower central surface of the nozzle body 120 toward the semiconductor substrate. The sprayed compressed air through the second passageway 126 may suppress an upward bending of the semiconductor substrate. That is, the upward bending of the semiconductor substrate may be suppressed by the compressed air applied to the flat supporting surface 122 through the second passageway 126.

Here, when the second passageway 126 has a cross-sectional area substantially the same as or larger than that of the first passageway 124, the compressed air introduced into the second passageway 126 may hinder the semiconductor substrate from being floated. To prevent the hindrance of the compressed air introduced into the second passageway 126, the cross-sectional area of the second passageway 126 may be smaller than the cross-sectional area of the first passageway 124.

According to this example embodiment, the flat supporting surface of the nozzle body may suppress the bending of the semiconductor substrate. Further, the compressed air introduced into the second passageway may also suppress the bending of the semiconductor substrate. As a result, the semiconductor substrate held by the vacuum may not be damaged.

Apparatus for Transferring a Substrate

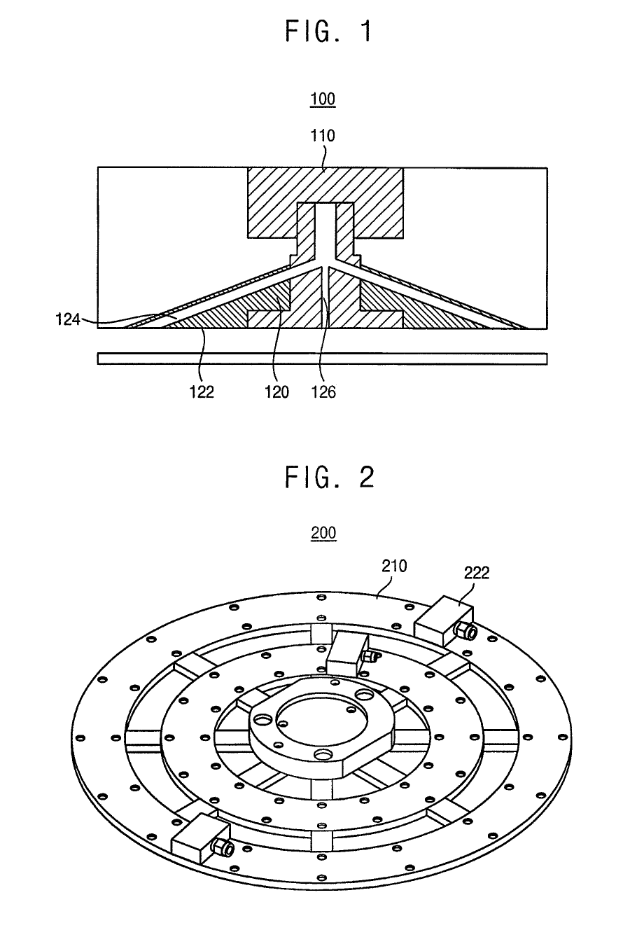

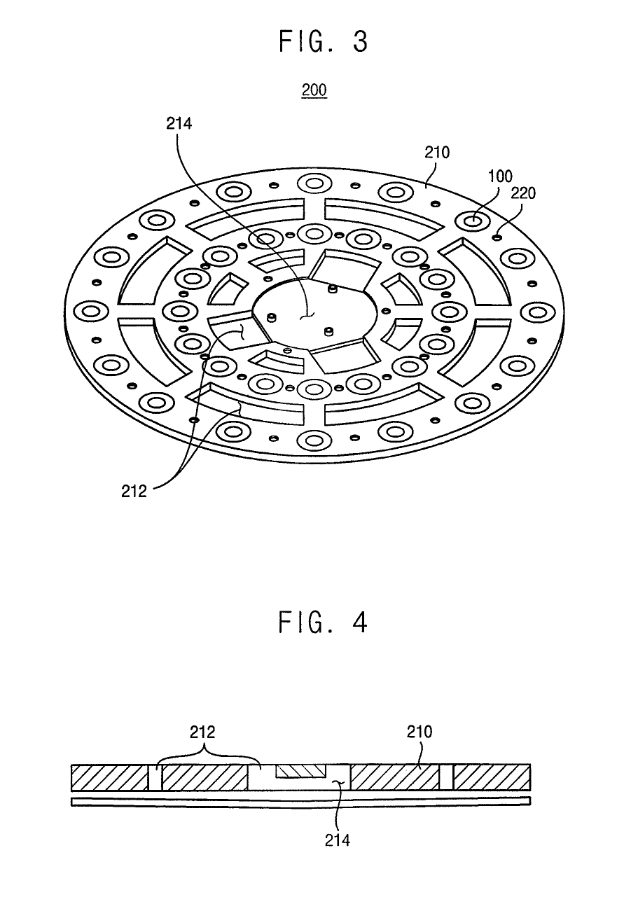

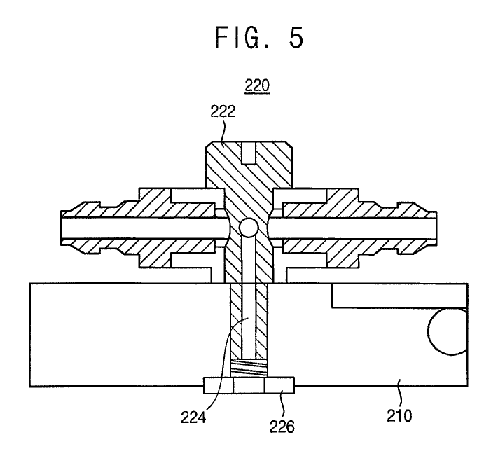

FIG. 2 is a perspective view illustrating an apparatus for transferring a substrate including the nozzle in FIG. 1, FIG. 3 is a bottom perspective view illustrating the apparatus in FIG. 2, FIG. 4 is a cross-sectional view illustrating a nozzle plate of the apparatus in FIG. 2, and FIG. 5 is a cross-sectional view illustrating a vacuum sensor of the apparatus in FIG. 3.

Referring to FIGS. 2 and 3, an apparatus 200 for transferring a substrate in accordance with this example embodiment may include a nozzle plate 210 and a plurality of nozzles 100.

In some example embodiments, the nozzle plate 210 may have, for example, a disc shape. The nozzle plate 210 may have a lower surface configured to adsorb a semiconductor substrate using a vacuum. Thus, the lower surface of the nozzle plate 210 may have a size substantially similar to that of the semiconductor substrate. A plurality of exhaust openings 212 may be formed through the nozzle plate 210. Compressed air, which may be sprayed toward a central portion of the nozzle plate 210 from the nozzles 100, may be exhausted through the exhaust openings 212. The exhaust openings 212 may be formed along a radius direction of the nozzle plate 210.

Referring to FIGS. 3 and 4, the nozzle plate 210 may have a receiving groove 214 configured to receive the compressed air. In some example embodiments, the receiving groove 214 may be formed at a lower central surface of the nozzle plate 210. Thus, the lower surface of the nozzle plate 210 may have an edge portion and the central portion higher than the edge portion. A gap between the edge portion of the lower surface of the nozzle plate 210 and the semiconductor substrate may be wider than a gap between the central portion of the lower surface of the nozzle plate 210 and the semiconductor substrate. The compressed air sprayed from the nozzles 100 may be received in the receiving groove 214.

The compressed air sprayed from the nozzles 100 may be moved toward the central portion of the nozzle plate 210. When a space between the central portion of the lower surface of the nozzle plate 210 and the semiconductor substrate is narrow, the compressed air may not be readily exhausted through the exhaust openings 212. As a result, the compressed air may be applied to the central portion of the semiconductor substrate, so that the central portion of the semiconductor substrate may be downwardly bent. In contrast, according to this example embodiment, the receiving groove 214 under the lower central surface of the nozzle plate 210 may form a sufficient space configured to receive the compressed air. Thus, the compressed air may be readily exhausted through the exhaust openings, so that the downward bending of the central portion of the semiconductor substrate may be suppressed.

Referring to FIGS. 2 and 3, the nozzles 100 may be installed at the nozzle plate 210. In some example embodiments, the nozzles 100 may be fixed to the nozzle plate 100 by, for example, an epoxy molding process. Further, for example, O-rings may be used for installing the nozzles 100.

Here, the nozzles 100 may include elements substantially the same as those of the nozzles in FIG. 1. Therefore, any further illustrations with respect to the same elements are omitted herein for brevity.

Additionally, vacuum sensors 220 for detecting the floating of the semiconductor substrate may be installed at the nozzle plate 210. With reference to FIG. 5, each of the vacuum sensors 220 may include a fitting 222 and a pad 226.

In some example embodiments, the fitting 222 may be inserted through the nozzle plate 210. The fitting 222 may have a vacuum passageway 224 through which the vacuum passes.

The pad 226 may be attached to a lower end of the fitting 222 exposed through the lower surface of the nozzle plate 210. The pad 226 may be slightly exposed from the lower surface of the nozzle plate 210 to prevent the substrate from sliding. Thus, the floated semiconductor substrate may make contact with the pad 226, not the nozzles 100. When the semiconductor substrate makes contact with the pad 226 by a normal floating, the semiconductor substrate may block the vacuum passageway 224. As a result, an inner pressure of the vacuum passageway 224 may be decreased. The vacuum sensor 220 may detect the lower inner pressure of the vacuum passageway 224 to recognize the normal floating of the semiconductor substrate. In contrast, when the semiconductor substrate does not block the vacuum passageway 224 by an abnormal floating, the inner pressure of the vacuum passageway 224 may not be decreased. The vacuum sensor 220 may detect the maintained inner pressure of the vacuum passageway 224 to recognize the abnormal floating of the semiconductor substrate. As a result, an operation for transferring the abnormally floated semiconductor substrate may be suspended.

In some example embodiments, to prevent the generation of particles from the pad 226, the pad 226 may include an inactive material such as, for example, fluorine.

Here, in this example embodiment, the object may include the semiconductor substrate. Alternatively, the nozzle and the transferring apparatus may be applied to other thin substrates.

According to these example embodiments, the compressed air may be supplied to the substrate through the central portion of the nozzle, so that the upward bending of the nozzle caused by the vacuum may be suppressed. Further, the compressed air sprayed from the nozzles may be received in the receiving grooves of the nozzle plate. Thus, the pressure of the compressed air applied to the central portion of the substrate may be decreased, so that the downward bending of the substrate may be suppressed.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A nozzle for holding a substrate, the nozzle comprising:
a nozzle head for providing the substrate with compressed air; and
a nozzle body connected to the nozzle head and arranged facing the substrate, the nozzle body having a substantially flat supporting surface and a first passageway, the substantially flat supporting surface providing a uniform gap between the substrate and the nozzle body, and the first passageway allowing the compressed air to pass through toward the substrate to form a vacuum between the substantially flat supporting surface and the substrate.

2. The nozzle of claim 1, wherein the nozzle body has a second passageway allowing the compressed air to pass through toward a portion of the substrate corresponding to a central portion of the nozzle body for preventing an upward bending of the substrate by the vacuum.

3. The nozzle of claim 2, wherein the second passageway has a cross-sectional area smaller than that of the first passageway.

4. A nozzle for holding a substrate, the nozzle comprising:
a nozzle head for providing the substrate with compressed air; and
a nozzle body connected to the nozzle head, the nozzle body having a substantially flat supporting surface, a first passageway and a second passageway, the substantially flat supporting surface facing the substrate, the first passageway allowing the compressed air to pass through toward the substrate to form a vacuum between the substantially flat supporting surface and the substrate, and the second passageway allowing the compressed air to pass through toward a portion of the substrate corresponding to a central portion of the nozzle body for preventing an upward bending of the substrate by the vacuum.

5. The nozzle of claim 4, wherein the second passageway has a cross-sectional area smaller than that of the first passageway.

6. An apparatus for transferring a substrate, the apparatus comprising:
a nozzle plate arranged over the substrate; and
a plurality of nozzles installed at the nozzle plate, each of the nozzles including a substantially flat supporting surface and a first passageway, the substantially flat supporting surface providing a uniform gap between the substrate and the nozzle, and the first passageway allowing the compressed air to pass through toward the substrate to foam a vacuum between the substantially flat supporting surface and the substrate.

7. The apparatus of claim 6, wherein the nozzle plate has a receiving groove configured to receive the compressed air for preventing a central portion of the substrate from being downwardly bent by the compressed air.

8. The apparatus of claim 6, further comprising a vacuum sensor installed at the nozzle plate to detect a floating of the semiconductor substrate using a vacuum.

9. The apparatus of claim 8, wherein the vacuum sensor comprises a pad protruded from the nozzle plate and in direct contact with the substrate for preventing a sliding of the substrate.

10. The apparatus of claim 6, wherein each of the nozzles has a second passageway allowing the compressed air to pass through toward the substrate for preventing an upward bending of the substrate by the vacuum.

11. The apparatus claim 6, wherein the nozzle plate has a disc shape.

12. The apparatus of claim 6, wherein a lower surface of the nozzle plate has a size substantially similar to that of the substrate.

13. The apparatus of claim 6, wherein the nozzle plate includes a plurality of exhaust openings therein.

14. The apparatus of claim 11, wherein the plurality of exhaust openings are formed along a radius direction of the nozzle plate.

15. The apparatus of claim 7, wherein a lower surface of the nozzle plate has an edge portion and a central portion higher than the edge portion.

16. The apparatus of claim 15, wherein the receiving groove is formed at the lower central surface of the nozzle plate.

17. The apparatus of claim 16, wherein a gap between the edge portion of the lower surface of the nozzle plate and the semiconductor substrate is wider than a gap between the central portion of the lower surface of the nozzle plate and the semiconductor substrate.

18. The apparatus of claim 9, wherein the vacuum sensor further comprises a fitting inserted through the nozzle plate, and wherein the fitting has a vacuum passageway through which the vacuum passes.

19. The apparatus of claim 18, wherein the pad is attached to a lower end of the fitting exposed through a lower surface of the nozzle plate.

20. The apparatus of claim 18, wherein the pad includes fluorine.
